(19) United States
(12) Patent Application Publication
(10) Pub. No.: US 2022/0010195 A1
(43) Pub. Date: Jan. 13, 2022

(54) NEUTRALIZE HAZARD GASES CONTROL SYSTEM

(71) Applicant: Saudi Arabian Oil Company, Dhahran (SA)

(72) Inventors: Mahmoud Adnan Alqurashi, Dhahran (SA); Mohammed Y. Al Daif, Qatif (SA); Ali E. Dossary, Dammam (SA)

(21) Appl. No.: 16/925,936

(22) Filed: Jul. 10, 2020

(51) Int. Cl. C09K 8/532; E21B 21/06; E21B 21/16

(52) U.S. Cl. CPC C09K 8/532; E21B 21/068; C09K 2208/20; E21B 21/16; E21B 21/062

(57) ABSTRACT

Systems and methods include a computer-implemented method for neutralizing hazardous gases. Indications of a hazardous gas leak occurring in a detected release area are received at a neutralize hazardous gases (NHS) control system from one or more gas sensors of a production facility. In response to receiving the indications of the hazardous gas leak, hydrogen sulfide (H₂S) scavengers are sprayed into the detected release areas by scavenger injection nozzles controlled by the NHS control system. An expandable containment fence is launched by the NHS control system. The expandable containment fence includes a membrane net. The expandable containment fence is configured to contain the hazardous gas leak by preventing the hazardous gas leak from spreading horizontally.

### BACKGROUND

The present disclosure applies to controlling hazardous gas releases in the petroleum industry.

During operations in the oil and gas industry, hazardous materials such as underground fluids or gas accumulations can sometimes be introduced to the surface. For example, when certain drilling problems or issues occur, hazardous fluids or gas can find its way to the surface and be released into the environment. When such an event occurs, appropriate action may not be taken in a timely manner by pressure control equipment or drilling crews. As a result, the well can enter an uncontrolled state. Situations can worsen to the point that tremendous efforts to regain control are unable to control the well. As a result, catastrophic events can occur, including explosions, spills, and toxic clouds, and fires. In some cases, as a final resort, a decision can be made to ignite the drilling rig in order to burn off the hazardous materials.

Conventional systems typically activate gas detectors only after release, for example, of hazardous gas. While a well might be shut down, hazardous gas would still be released into the atmosphere, posing danger to residents and personnel in the area. In conventional practices, when toxic gases are leaked and no way exist to control the leak, a flare gun can be used to ignite a well or rig to stop toxic gases from spreading.

### SUMMARY

The present disclosure describes techniques that can be used to implement and provide a control system for neutralizing hazardous gases. In some implementations, a computer-implemented method includes the following. Indications of a hazardous gas leak occurring in a detected release area are received at a neutralize hazardous gases (NHS) control system from one or more gas sensors of a production facility. In response to receiving the indications of the hazardous gas leak, hydrogen sulfide (H₂S) scavengers are sprayed into the detected release areas by scavenger injection nozzles controlled by the NHS control system. An expandable containment fence is launched by the NHS control system. The expandable containment fence includes a membrane net. The expandable containment fence is configured to contain the hazardous gas leak by preventing the hazardous gas leak from spreading horizontally.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method/the instructions stored on the non-transitory, computer-readable medium.

The subject matter described in this specification can be implemented in particular implementations, so as to realize one or more of the following advantages. First, a system can facilitate the immediate reaction to a gas release at the moment that the gas is detected, without requiring human intervention. This can allow the system to begin immediately to neutralize the gas. This can also allow personnel to continue working in the area and to take required steps to troubleshoot and fix problems. The system can be designed to be flexible and allow easy adjustment. For example, the system can be programmed to use specific chemicals that will serve the purpose of neutralizing gas toxicity and reducing/mitigating hazards. Second, safety can be enhanced, including improving Quality, Health, Safety, and Environment (QHSE) management, integrating common elements of various safety standards. As an example, the system can provide intelligent Industrial Revolution (IR) 4.0 surface equipment and a system that acts as defensive line in the case of an emergency. Third, evacuation can occur as needed in case of a toxic gas release in order to implement safety measures and to save lives and assets. Ideally, the system would neutralize toxic gases immediately. However, due to the high risk on personnel, evacuation may be essential to assure that personnel are not harmed during the process. At high concentrations of hydrogen sulfide (H₂S) and other harmful gases, the system can significantly reduce the concentration but may not completely eliminate the gas presence. This can provide another reason for evacuation, such as when a greater risk to human beings exists and when there is a greater risk of an ignition and fire at the facility if the leakage is big. Fourth, because resources can be saved due to the presence of a system, and insurance risk and reliabilities can be reduced. Fifth, the environment can be better protected. Sixth, industry reputation can be protected and preserved. Seventh, the system can spray scavenger gases to contain or displace toxic gas after the gas is released. This provides an advantage over conventional systems that are limited into injecting scavengers into the piping to reduce the concentration of H₂S and limit the impact on the piping. Eighth, techniques of the present disclosure can provide an advantage over conventional systems that rely on gas sensors to detect leaks and alarm people to evacuate, for example, by controlling released gases. Ninth, the detection system can be installed anywhere on a rig.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIGS. 1 and 2 are diagrams of an example of a system for neutralizing hazardous gases, according to some implementations of the present disclosure.

FIG. 3 is a diagram of an example of a system for neutralizing hazardous gases, according to some implementations of the present disclosure.

FIG. 4 is a flowchart of an example of a method for providing a control system for neutralizing hazardous gases, according to some implementations of the present disclosure.

FIG. 5 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques that can be used to implement and provide a control system for neutralizing hazardous gases. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

Techniques of the present disclosure can be used to a neutralize hazardous gases (NHS) control system for dealing with hydrogen sulfide and Lower Explosive Limit (LEL) gases that can be released in the Oil and Gas Industry. The NHS control system can be pre-installed, for example, around blowout preventers (BOPs), Christmas (X) tree area, surface well testing area, and mud returns lines. The NHS control system can be connected to LEL and H₂S gas sensors and operate accordingly by spraying H₂S scavengers around a detected release area. The NHS control system can include a programmed logical command (PLC) device to send alerts and notifications. The NHS control system can be control the ejection of a fence with a membrane net around a leaking area, where the NHS control system can also spray H₂S scavengers. The NHS control system can include a command center for entering and executing override commands to shut off the system or any connected devices. The NHS control system can also be referred to as a Naturalized Hazard Device (NHD).

The NHS control system can be installed at any point and location as seen fit. The NHS control system can help detect any leak around the high risk area, such as a BOP, a wellhead and X-tree during drilling operations, and well testing surface equipment during well testing operations. Moreover, the NHS control system can also be installed for non-drilling operations of a production site.

One main purpose of the NHS control system is to allow more time for personnel (for example, a team or crew) to react to a leak of hazardous gases, such as H₂S. Upon detection of a leak, in addition to alerting the crew, the system can be activated to neutralize the toxic gases. This can allow the crew to react properly (if possible) or to escape safely without being exposed and effected. H₂S is, in particular, a very harmful gas which can cause major health issues to a person. For example, a person can be severely injured or killed if exposed to high instantaneous H₂S concentration or medium/moderate concentrations for an extended period of time. In light of this risk, a purpose of the NHS control system is to reduce concentrations of hazard gases as much as possible. The reduction of exposure can be accomplished, for example, using scavengers that are readily available in industry, allowing more time for the crew to react properly.

H₂S and some other toxic gases are heavy gases and tend to stay low and travel horizontally rather than moving vertically. Spraying around a leaking area with scavengers can help neutralize the gases. Also, an expandable fence with a membrane can be used to contain the gases, keeping the gases from spreading horizontally and provide a crew with a safe and time-efficient reaction time after a leak is detected. These actions can save humans and resources and act as a mitigation measure for areas when drilling, or in operations with high H₂S and toxicity gas level.

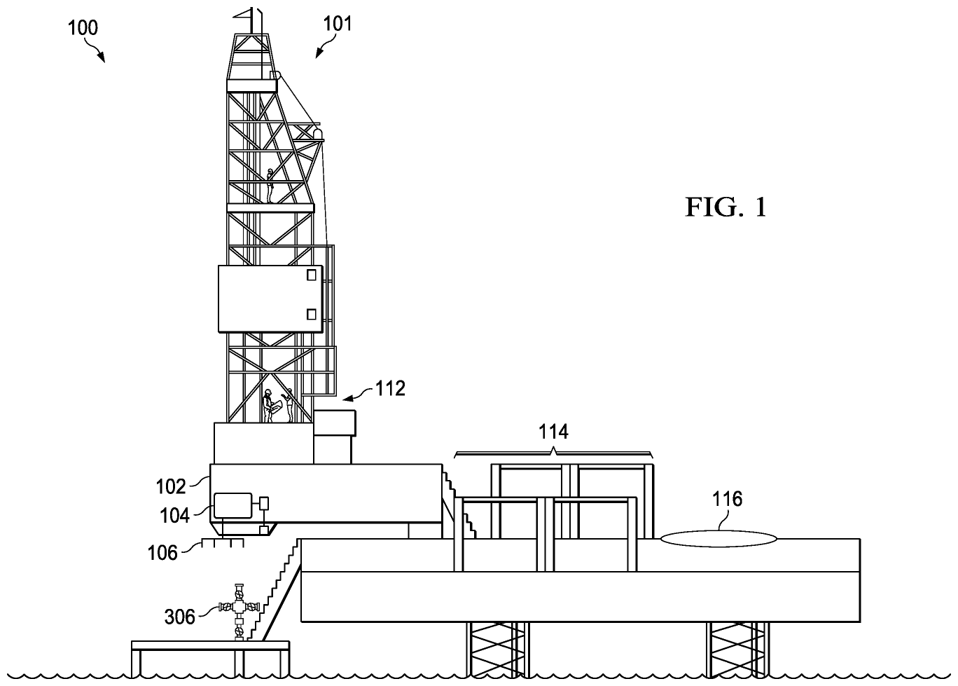

FIGS. 1 and 2 are diagrams of an example of a system 100 for neutralizing hazardous gases, according to some implementations of the present disclosure. The system 100 can be used on an oil rig 101, for example. The system 100 can be an NHS control system that includes the following components. A Neutralize Hazard device can include a PLC with wireless communication device 102, a toxic gases scavenger reservoir (or tank) 104, spray lines/outlets 106, and an H₂S and LEL detection device. Liquid H₂S scavenger 108, H₂S and toxic gases leak 110, and workers 112.

The system 100 includes an expandable fence 114 with toxic gases absorption material. The expandable fence can include fixed beams, a membrane material with solid H₂S absorption material, an expandable non-permeable fence full of solid H₂S absorption material, a rail to allow fence to expand fully from one beam to another, and a motor. The motor can be connected to the PLC and gas detection device to activate the fence, causing the fence to expand like a curtain and open to the other end (or other beam). The fence can be used to contain H₂S and toxic gases. These gases are heavy and tend to remain low to the ground but can expand fast horizontally. Upon detection of a gas leak, workers 112 can gather in an assembly area 116. FIG. 2 shows an example of gas flow 118 during a leak.

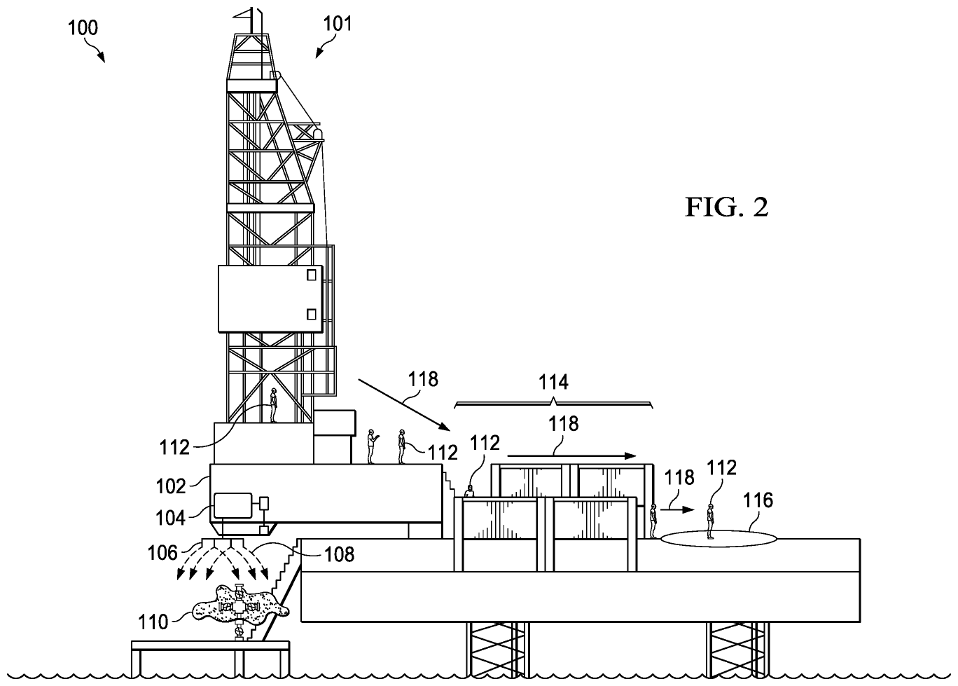

FIG. 3 is a diagram of an example of a system 300 for neutralizing hazardous gases, according to some implementations of the present disclosure. The system 300 includes elements of the system 100, for example. The system 300 includes a fence membrane 302 that has been deployed to contain a hazardous gas release (for example, H₂S and toxic gases leak 304) from pipes 306. The fence membrane 302 can include a toxic gases absorption material. The fence membrane 302 can be fit to cover from the ground to the height of the fence. In some implementations, a weight on the bottom of the fence membrane 302 can be added as an extra safety measure. Materials that are used for the membrane can make the membrane non-permeable from the inside (for example, blocking an escape path). The outside of the membrane can include a mesh that provides an absorbent material to capture any H₂S. The features of the membrane can work together to provide an isolation and safer means to allow escape (by personnel) and a way to contain the leak. The fence can expand from one side to the other and remain in a tension mode to assure robustness. The membrane can include or work as a sponge with H₂S scavengers that can provide absorbance in a containment area while being non-permeable from the outside.

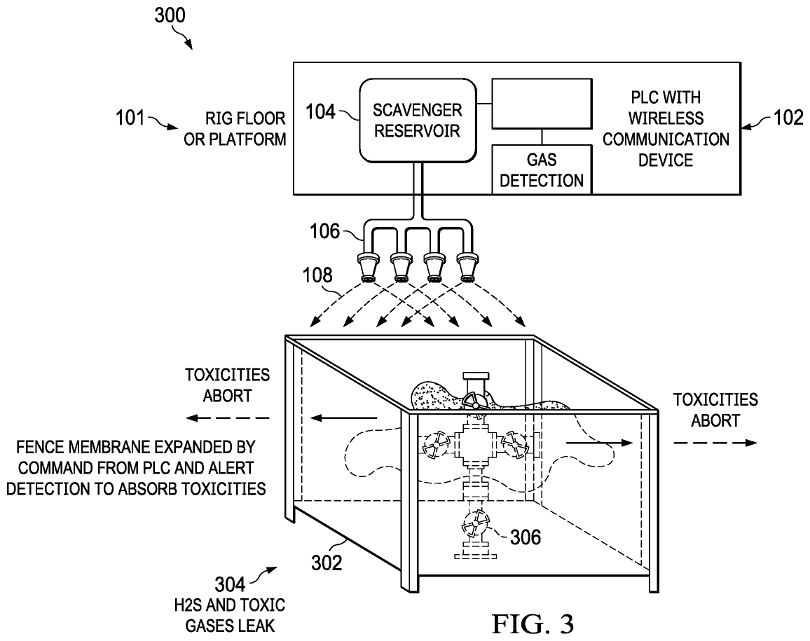

FIG. 4 is a flowchart of an example of a method 400 for providing a control system for neutralizing hazardous gases, according to some implementations of the present disclosure. For clarity of presentation, the description that follows generally describes method 400 in the context of the other figures in this description. However, it will be understood that method 400 can be performed, for example, by any suitable system, environment, software, and hardware, or a combination of systems, environments, software, and hardware, as appropriate. In some implementations, various steps of method 400 can be run in parallel, in combination, in loops, or in any order.

At 402, indications of a hazardous gas leak occurring in a detected release area are received at a neutralize hazardous gases (NHS) control system from one or more gas sensors of a production facility. The hazardous gas release can occur from the pipes 306, for example, which may exist at the oil rig 101. In some implementations, receiving the indications of the hazardous gas leak occurring in the detected release area can include determining that a leak has occurred above a threshold concentration of H₂S. For example, the threshold concentration of H₂S can be 300 parts per million (ppm). In some implementations, a default setting can be provided for the NHS control system to react to different concentrations of different gases (for example, 300 ppm for H₂S, and different other concentrations for other gases). From 402, method 400 proceeds to 404.

At 404, in response to receiving the indications of the hazardous gas leak, hydrogen sulfide (H₂S) scavengers are sprayed into the detected release areas by scavenger injection nozzles controlled by the NHS control system. As an example, the spray lines/outlets 106 can spray H₂S scavenger obtained from the liquid H₂S scavenger. From 404, method 400 proceeds to 406.

At 406, an expandable containment fence is launched by the NHS control system. The expandable containment fence includes a membrane net. The expandable containment fence is configured to contain the hazardous gas leak by preventing the hazardous gas leak from spreading horizontally. After 406, method 400 can stop.

In some implementations, method 400 further includes sending, by the NHS control system, communications before, during, and after the hazardous gas leak. The communications can include notifications and alerts. Notifications can indicate situations, for example, in which no hazardous gas leak has occurred, or that the leak has been contained. Alerts can include messages that a leak has been detected and that particular equipment has been shut down, agencies or groups have been contacted, evacuations have been started, or particular gas concentrations have been detected.

In some implementations, method 400 further includes the use of a graphical user interface (GUI) controlling the NHS control system. For example, a GUI configured as a command center for the NHS control system is presenting by the NHS control system for display to a user. The display can appear at a workstation at the oil facility, for example. Information about the hazardous gas leak is displaying, through the GUI. The information can include, for example, concentration levels of particular hazardous gases. User inputs are received though the GUI. The user inputs include inputs to override commands of the NHS control system and inputs to shut down selected components and connected devices of the production facility. The NHS control system can take actions based on the user inputs, such as to cancel alerts, restart equipment that has been automatically shut down, and to raise the expandable containment fence after the hazardous gas leak is contained.

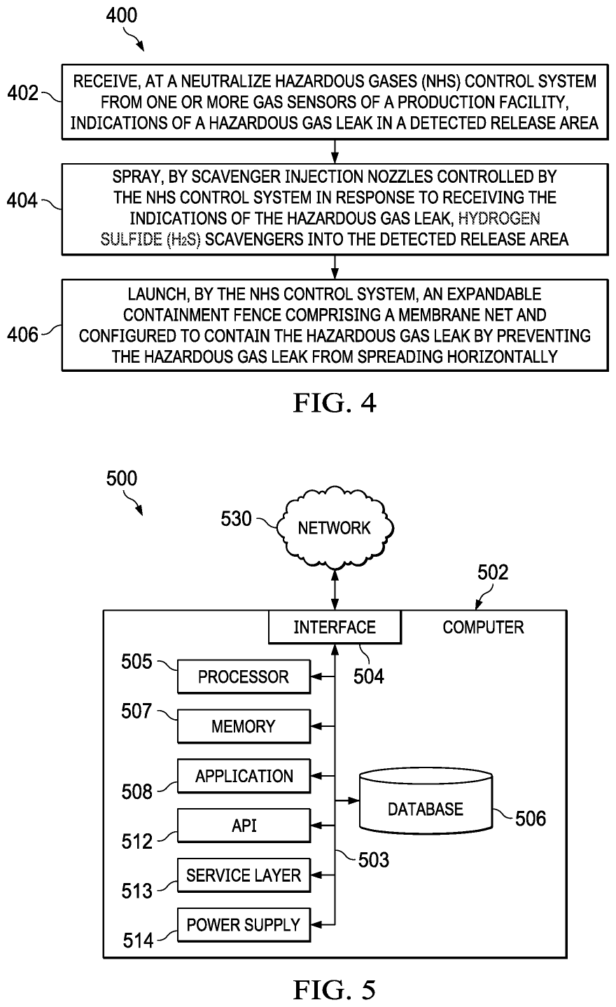

FIG. 5 is a block diagram of an example computer system 500 used to provide computational functionalities associated with described algorithms, methods, functions, processes, flows, and procedures described in the present disclosure, according to some implementations of the present disclosure. The illustrated computer 502 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. Also, the computer 502 can include output devices that can convey information associated with the operation of the computer 502. The information can include digital data, visual data, audio information, or a combination of information. The information can be presented in a graphical user interface (UI) (or GUI).

The computer 502 can serve in a role as a client, a network component, a server, a database, a persistency, or components of a computer system for performing the subject matter described in the present disclosure. The illustrated computer 502 is communicably coupled with a network 530. In some implementations, one or more components of the computer 502 can be configured to operate within different environments, including cloud-computing-based environments, local environments, global environments, and combinations of environments.

At a top level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 530 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 503. In some implementations, any or all of the components of the computer 502, including hardware or software components, can interface with each other or the interface 504 (or a combination of both) over the system bus 503. Interfaces can use an application programming interface (API) 512, a service layer 513, or a combination of the API 512 and service layer 513. The API 512 can include specifications for routines, data structures, and object classes. The API 512 can be either computer-language independent or dependent. The API 512 can refer to a complete interface, a single function, or a set of APIs.

The service layer 513 can provide software services to the computer 502 and other components (whether illustrated or not) that are communicably coupled to the computer 502. The functionality of the computer 502 can be accessible for all service consumers using this service layer. Software services, such as those provided by the service layer 513, can provide reusable, defined functionalities through a defined interface. For example, the interface can be software written in JAVA, C++, or a language providing data in extensible markup language (XML) format. While illustrated as an integrated component of the computer 502, in alternative implementations, the API 512 or the service layer 513 can be stand-alone components in relation to other components of the computer 502 and other components communicably coupled to the computer 502. Moreover, any or all parts of the API 512 or the service layer 513 can be implemented as child or sub-modules of another software module, enterprise application, or hardware module without departing from the scope of the present disclosure.

The computer 502 includes an interface 504. Although illustrated as a single interface 504 in FIG. 5, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the interface's hardware can be operable to communicate physical signals within and outside of the illustrated computer 502.

The computer 502 includes a processor 505. Although illustrated as a single processor 505 in FIG. 5, two or more processors 505 can be used according to particular needs, desires, or particular implementations of the computer 502 and the described functionality. Generally, the processor 505 can execute instructions and can manipulate data to perform the operations of the computer 502, including operations using algorithms, methods, functions, processes, flows, and procedures as described in the present disclosure.

The computer 502 also includes a database 506 that can hold data for the computer 502 and other components connected to the network 530 (whether illustrated or not). For example, database 506 can be an in-memory, conventional, or a database storing data consistent with the present disclosure. In some implementations, database 506 can be a combination of two or more different database types (for example, hybrid in-memory and conventional databases) according to particular needs, desires, or particular implementations of the computer 502 and the described functionality. Although illustrated as a single database 506 in FIG. 5, two or more databases (of the same, different, or combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

The application 508 can be an algorithmic software engine providing functionality according to particular needs, desires, or particular implementations of the computer 502 and the described functionality. For example, application 508 can serve as one or more components, modules, or applications. Further, although illustrated as a single application 508, the application 508 can be implemented as multiple applications 508 on the computer 502. In addition, although illustrated as internal to the computer 502, in alternative implementations, the application 508 can be external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion and management circuits, including recharging, standby, and power management functionalities. In some implementations, the power-supply 514 can include a power plug to allow the computer 502 to be plugged into a wall socket or a power source to, for example, power the computer 502 or recharge a rechargeable battery.

There can be any number of computers 502 associated with, or external to, a computer system containing computer 502, with each computer 502 communicating over network 530. Further, the terms “client,” “user,” and other appropriate terminology can be used interchangeably, as appropriate, without departing from the scope of the present disclosure. Moreover, the present disclosure contemplates that many users can use one computer 502 and one user can use multiple computers 502.

Described implementations of the subject matter can include one or more features, alone or in combination.

For example, in a first implementation, a computer-implemented method includes the following. Indications of a hazardous gas leak occurring in a detected release area are received at a neutralize hazardous gases (NHS) control system from one or more gas sensors of a production facility. In response to receiving the indications of the hazardous gas leak, hydrogen sulfide (H₂S) scavengers are sprayed into the detected release areas by scavenger injection nozzles controlled by the NHS control system. An expandable containment fence is launched by the NHS control system. The expandable containment fence includes a membrane net. The expandable containment fence is configured to contain the hazardous gas leak by preventing the hazardous gas leak from spreading horizontally.

The foregoing and other described implementations can each, optionally, include one or more of the following features:

A first feature, combinable with any of the following features, the method further including sending, by the NHS control system, communications before, during, and after the hazardous gas leak, where the communications include notifications and alerts.

A second feature, combinable with any of the previous or following features, the method further including: presenting, by the NHS control system, a graphical user interface (GUI) configured as a command center for the NHS control system; displaying, through the GUI, information about the hazardous gas leak, including concentration levels of particular hazardous gases; and receiving, though the GUI, user inputs including inputs to override commands of the NHS control system and inputs to shut down selected components and connected devices of the production facility.

A third feature, combinable with any of the previous or following features, where the membrane net includes a toxic gases absorption material.

A fourth feature, combinable with any of the previous or following features, where receiving the indications of the hazardous gas leak occurring in the detected release area includes determining that a leak has occurred above a threshold concentration of H₂S.

A fifth feature, combinable with any of the previous or following features, where the threshold concentration of H₂S is 300 parts per million (ppm).

A sixth feature, combinable with any of the previous or following features, the method further including providing a default setting for the NHS control system to react to different concentrations of different gases.

In a second implementation, a non-transitory, computer-readable medium stores one or more instructions executable by a computer system to perform operations including the following. Indications of a hazardous gas leak occurring in a detected release area are received at a neutralize hazardous gases (NHS) control system from one or more gas sensors of a production facility. In response to receiving the indications of the hazardous gas leak, hydrogen sulfide (H₂S) scavengers are sprayed into the detected release areas by scavenger injection nozzles controlled by the NHS control system. An expandable containment fence is launched by the NHS control system. The expandable containment fence includes a membrane net. The expandable containment fence is configured to contain the hazardous gas leak by preventing the hazardous gas leak from spreading horizontally.

The foregoing and other described implementations can each, optionally, include one or more of the following features:

A first feature, combinable with any of the following features, the operations further including sending, by the NHS control system, communications before, during, and after the hazardous gas leak, where the communications include notifications and alerts.

A second feature, combinable with any of the previous or following features, the operations further including: presenting, by the NHS control system, a graphical user interface (GUI) configured as a command center for the NHS control system; displaying, through the GUI, information about the hazardous gas leak, including concentration levels of particular hazardous gases; and receiving, though the GUI, user inputs including inputs to override commands of the NHS control system and inputs to shut down selected components and connected devices of the production facility.

A third feature, combinable with any of the previous or following features, where the membrane net includes a toxic gases absorption material.

A fourth feature, combinable with any of the previous or following features, where receiving the indications of the hazardous gas leak occurring in the detected release area includes determining that a leak has occurred above a threshold concentration of H₂S.

A fifth feature, combinable with any of the previous or following features, where the threshold concentration of H₂S is 300 parts per million (ppm).

A sixth feature, combinable with any of the previous or following features, the operations further including providing a default setting for the NHS control system to react to different concentrations of different gases.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. Indications of a hazardous gas leak occurring in a detected release area are received at a neutralize hazardous gases (NHS) control system from one or more gas sensors of a production facility. In response to receiving the indications of the hazardous gas leak, hydrogen sulfide (H₂S) scavengers are sprayed into the detected release areas by scavenger injection nozzles controlled by the NHS control system. An expandable containment fence is launched by the NHS control system. The expandable containment fence includes a membrane net. The expandable containment fence is configured to contain the hazardous gas leak by preventing the hazardous gas leak from spreading horizontally.

The foregoing and other described implementations can each, optionally, include one or more of the following features:

A first feature, combinable with any of the following features, the operations further including sending, by the NHS control system, communications before, during, and after the hazardous gas leak, where the communications include notifications and alerts.

A second feature, combinable with any of the previous or following features, the operations further including: presenting, by the NHS control system, a graphical user interface (GUI) configured as a command center for the NHS control system; displaying, through the GUI, information about the hazardous gas leak, including concentration levels of particular hazardous gases; and receiving, though the GUI, user inputs including inputs to override commands of the NHS control system and inputs to shut down selected components and connected devices of the production facility.

A third feature, combinable with any of the previous or following features, where the membrane net includes a toxic gases absorption material.

A fourth feature, combinable with any of the previous or following features, where receiving the indications of the hazardous gas leak occurring in the detected release area includes determining that a leak has occurred above a threshold concentration of H₂S.

A fifth feature, combinable with any of the previous or following features, where the threshold concentration of H₂S is 300 parts per million (ppm). Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
receiving, at a neutralize hazardous gases (NHS) control system from one or more gas sensors of a production facility, indications of a hazardous gas leak occurring in a detected release area;
spraying, by scavenger injection nozzles controlled by the NHS control system in response to receiving the indications of the hazardous gas leak, hydrogen sulfide (H₂S) scavengers into the detected release area; and
launching, by the NHS control system, an expandable containment fence comprising a membrane net and configured to contain the hazardous gas leak by preventing the hazardous gas leak from spreading horizontally.

2. The computer-implemented method of claim 1, further comprising:
sending, by the NHS control system, communications before, during, and after the hazardous gas leak, wherein the communications include notifications and alerts.

3. The computer-implemented method of claim 1, further comprising:
presenting, by the NHS control system, a graphical user interface (GUI) configured as a command center for the NHS control system;
displaying, through the GUI, information about the hazardous gas leak, including concentration levels of particular hazardous gases; and
receiving, though the GUI, user inputs including inputs to override commands of the NHS control system and inputs to shut down selected components and connected devices of the production facility.

4. The computer-implemented method of claim 1, wherein the membrane net includes a toxic gases absorption material.

5. The computer-implemented method of claim 1, wherein receiving the indications of the hazardous gas leak occurring in the detected release area includes determining that a leak has occurred above a threshold concentration of H₂S.

6. The computer-implemented method of claim 5, wherein the threshold concentration of H₂S is 300 parts per million (ppm).

7. The computer-implemented method of claim 1, further comprising providing a default setting for the NHS control system to react to different concentrations of different gases.

8. A non-transitory, computer-readable medium storing one or more instructions executable by a computer system to perform operations comprising:
receiving, at a neutralize hazardous gases (NHS) control system from one or more gas sensors of a production facility, indications of a hazardous gas leak occurring in a detected release area;
spraying, by scavenger injection nozzles controlled by the NHS control system in response to receiving the indications of the hazardous gas leak, hydrogen sulfide (H₂S) scavengers into the detected release area; and
launching, by the NHS control system, an expandable containment fence comprising a membrane net and configured to contain the hazardous gas leak by preventing the hazardous gas leak from spreading horizontally.

9. The non-transitory, computer-readable medium of claim 8, the operations further comprising:
sending, by the NHS control system, communications before, during, and after the hazardous gas leak, wherein the communications include notifications and alerts.

10. The non-transitory, computer-readable medium of claim 8, the operations further comprising:
presenting, by the NHS control system, a graphical user interface (GUI) configured as a command center for the NHS control system;
displaying, through the GUI, information about the hazardous gas leak, including concentration levels of particular hazardous gases; and
receiving, though the GUI, user inputs including inputs to override commands of the NHS control system and inputs to shut down selected components and connected devices of the production facility.

11. The non-transitory, computer-readable medium of claim 8, wherein the membrane net includes a toxic gases absorption material.

12. The non-transitory, computer-readable medium of claim 8, wherein receiving the indications of the hazardous gas leak occurring in the detected release area includes determining that a leak has occurred above a threshold concentration of H₂S.

13. The non-transitory, computer-readable medium of claim 12, wherein the threshold concentration of H₂S is 300 parts per million (ppm).

14. The non-transitory, computer-readable medium of claim 8, the operations further comprising providing a default setting for the NHS control system to react to different concentrations of different gases.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
receiving, at a neutralize hazardous gases (NHS) control system from one or more gas sensors of a production facility, indications of a hazardous gas leak occurring in a detected release area;
spraying, by scavenger injection nozzles controlled by the NHS control system in response to receiving the indications of the hazardous gas leak, hydrogen sulfide (H₂S) scavengers into the detected release area; and
launching, by the NHS control system, an expandable containment fence comprising a membrane net and configured to contain the hazardous gas leak by preventing the hazardous gas leak from spreading horizontally.

16. The computer-implemented system of claim 15, the operations further comprising:
sending, by the NHS control system, communications before, during, and after the hazardous gas leak, wherein the communications include notifications and alerts.

17. The computer-implemented system of claim 15, the operations further comprising:
presenting, by the NHS control system, a graphical user interface (GUI) configured as a command center for the NHS control system;
displaying, through the GUI, information about the hazardous gas leak, including concentration levels of particular hazardous gases; and
receiving, though the GUI, user inputs including inputs to override commands of the NHS control system and inputs to shut down selected components and connected devices of the production facility.

18. The computer-implemented system of claim 15, wherein the membrane net includes a toxic gases absorption material.

19. The computer-implemented system of claim 15, wherein receiving the indications of the hazardous gas leak occurring in the detected release area includes determining that a leak has occurred above a threshold concentration of H₂S.

20. The computer-implemented system of claim 19, wherein the threshold concentration of H₂S is 300 parts per million (ppm).
